(19) United States
(12) Patent Application Publication
(10) Pub. No.: US 2026/0056417 A1
(43) Pub. Date: Feb. 26, 2026

(54) WEARABLE ELECTRONIC DEVICE AND OPERATING METHOD THEREOF

(71) Applicant: Samsung Electronics Co., Ltd., Suwon-si (KR)

(72) Inventors: Min-a SUH, Suwon-si (KR); Byunghwa LEE, Suwon-si (KR)

(21) Appl. No.: 19/172,279

(22) Filed: Apr. 7, 2025

Related U.S. Application Data
(63) Continuation of application No. PCT/KR2025/095045, filed on Mar. 20, 2025.

(30) Foreign Application Priority Data
Aug. 23, 2024 (KR) 10-2024-0113292
Sep. 11, 2024 (KR) 10-2024-0124075

(51) Int. Cl. G02B 27/01; G02B 27/00; G06F 3/16; G10K 11/175; G10K 11/26; H04R 1/02; H04R 1/32

(52) U.S. Cl. CPC G02B 27/0176; G02B 27/0093; G02B 27/0172; G06F 3/16; G10K 11/175; G10K 11/26; H04R 1/028; H04R 1/326; G02B 2027/0138; G02B 2027/014; G02B 2027/0178; G10K 2210/1081

(57) ABSTRACT

A wearable electronic device according to an embodiment may include a display, a microphone, a speaker, at least one processor including processing circuitry, and memory storing instructions. The instructions may, when individually or collectively executed by the at least one processor, cause the wearable electronic device to obtain a sound through the microphone in a state in which the wearable electronic device is worn on a user. The instructions may, when individually or collectively executed by the at least one processor, cause the wearable electronic device to identify whether the sound obtained through the microphone satisfies a condition for at least partially blocking a sound obtained by the wearable electronic device in a real space around the wearable electronic device. The instructions may, when individually or collectively executed by the at least one processor, cause the wearable electronic device to based on the sound obtained through the microphone satisfying the condition, set, as a blocking area, an area in the real space, the area corresponding to a direction from which the sound is obtained. The instructions may, when individually or collectively executed by the at least one processor, cause the wearable electronic device to based on a position of the wearable electronic device, display, through the display, an indicator representing the blocking area. The instructions may, when individually or collectively executed by the at least one processor, cause the wearable electronic device to at least partially block a sound obtained from a direction corresponding to the blocking area.

### CROSS-REFERENCE TO RELATED APPLICATIONS

This application is a continuation of International Application No. PCT/KR2025/095045 designating the United States, filed on Mar. 20, 2025, in the Korean Intellectual Property Receiving Office and claiming priority to Korean Patent Application Nos. 10-2024-0113292, filed on Aug. 23, 2024, and 10-2024-0124075, filed on Sep. 11, 2024, in the Korean Intellectual Property Office, the disclosures of each of which are incorporated by reference herein in their entireties.

### BACKGROUND

### Field

The disclosure relates to a wearable electronic device and an operating method thereof.

### Description of Related Art

The number of various services and additional functions provided through a wearable electronic device, such as augmented reality (AR) glasses, virtual reality (VR) glasses, and a head-mounted display (HMD) device, is gradually increasing. To increase the utility value of such a wearable electronic device and satisfy the needs of various users, communication service providers or wearable electronic device manufacturers are competitively developing wearable electronic devices to provide various functions and to be differentiated from other companies. Accordingly, various functions provided through a wearable electronic device are becoming increasingly sophisticated.

The above information is presented as background information only to assist with an understanding of the disclosure. No determination has been made, and no assertion is made, as to whether any of the above might be applicable as prior art with regard to the disclosure.

A wearable electronic device enables a user wearing the wearable electronic device (hereinafter, referred to as a “user”) to perform various tasks. For example, the user may perform a task related to a document using the wearable electronic device.

The user may want to be immersed in a task while performing the task with using the wearable electronic device. However, the user may need to perform the task using the wearable electronic device in an environment which makes it difficult to be immersed in the task (e.g., a place with a high noise level and surroundings distracting the user). In this case, the user may want to visually and acoustically block an area where noise occurs to be immersed in the task using the wearable electronic device. For example, the user may want to block noise from surroundings and to hide an area where noise occurs to be immersed in the task using the wearable electronic device.

### SUMMARY

Various embodiments of the disclosure relate to a wearable electronic device and an operating method thereof which are capable of providing an environment which enables a user to be immersed in a task with a wearable electronic device by blocking a direction from which noise occurs and/or an area where the noise occurs.

A wearable electronic device according to an embodiment may include a display, a microphone, a speaker, at least one processor including processing circuitry, and memory storing instructions. The instructions may, when individually or collectively executed by the at least one processor, cause the wearable electronic device to obtain a sound through the microphone in a state in which the wearable electronic device is worn on a user. The instructions may, when individually or collectively executed by the at least one processor, cause the wearable electronic device to identify whether the sound obtained through the microphone satisfies a condition for at least partially blocking a sound obtained by the wearable electronic device in a real space around the wearable electronic device. The instructions may, when individually or collectively executed by the at least one processor, cause the wearable electronic device to based on the sound obtained through the microphone satisfying the condition, set, as a blocking area, an area in the real space, the area corresponding to a direction from which the sound is obtained. The instructions may, when individually or collectively executed by the at least one processor, cause the wearable electronic device to based on a position of the wearable electronic device, display, through the display, an indicator representing the blocking area. The instructions may, when individually or collectively executed by the at least one processor, cause the wearable electronic device to at least partially block a sound obtained from a direction corresponding to the blocking area.

A method according to an embodiment may include obtaining, through a microphone of a wearable electronic device, a sound in a state in which the wearable electronic device is worn on a user. The method may include identifying whether the obtained sound satisfies a condition for at least partially blocking a sound obtained by the wearable electronic device in a real space around the wearable electronic device. The method may include based on the sound obtained through the microphone satisfying the condition, setting, as a blocking area, an area in the real space, the area corresponding to a direction from which the sound is obtained. The method may include based on a position of the wearable electronic device, displaying, through a display of the wearable electronic device, an indicator representing the blocking area. The method may include at least partially block a sound obtained from a direction corresponding to the blocking area.

A non-transitory computer-readable storage medium according to an embodiment may record computer-executable instructions, and the computer-executable instructions may, when individually or collectively executed by at least one processor, cause the wearable electronic device to obtain a sound through a microphone of the wearable electronic device in a state in which the wearable electronic device is worn on a user. The computer-executable instructions may, when individually or collectively executed by the at least one processor, cause the wearable electronic device to identify whether the sound obtained through the microphone satisfies a condition for at least partially blocking a sound obtained by the wearable electronic device in a real space around the wearable electronic device. The computer-executable instructions may, when individually or collectively executed by the at least one processor, cause the wearable electronic device to based on the sound obtained through the microphone satisfying the condition, set, as a blocking area, an area in the real space, the area corresponding to a direction from which the sound is obtained. The computer-executable instructions may, when individually or collectively executed by the at least one processor, cause the wearable electronic device to based on a position of the wearable electronic device, display, through a display of the wearable electronic device, an indicator representing the blocking area. The computer-executable instructions may, when individually or collectively executed by the at least one processor, cause the wearable electronic device to at least partially block a sound obtained from a direction corresponding to the blocking area.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2 is a perspective view illustrating an example electronic device according to various embodiments;

FIG. 3A is a perspective view illustrating the front of an example wearable electronic device according to various embodiments;

FIG. 3B is a perspective view illustrating the back of an example wearable electronic device according to various embodiments;

FIG. 4 is a block diagram illustrating an example configuration of a wearable electronic device according to various embodiments;

FIG. 5 is a flowchart illustrating an example operation of a wearable electronic device according to various embodiments;

FIG. 6A is a diagram illustrating a sound blocking condition according to various embodiments;

FIG. 6B is a diagram illustrating a sound blocking condition according to various embodiments;

FIG. 7 is a diagram illustrating an example method of setting a blocking area according to various embodiments;

FIG. 8 is a diagram illustrating an example method of setting a blocking area according to various embodiments;

FIG. 9 is a diagram illustrating an example method of setting a blocking area according to various embodiments;

FIG. 10 is a diagram illustrating an example method of setting a blocking area according to various embodiments;

FIG. 11 is a diagram illustrating an example method of setting a blocking area according to various embodiments;

FIG. 12 is a diagram illustrating an example method of setting a blocking area according to various embodiments;

FIG. 13 is a diagram illustrating an example method of displaying an indicator indicating a blocking area according to various embodiments;

FIG. 14 is a diagram illustrating an example method of displaying an indicator indicating a blocking area according to various embodiments;

FIG. 15 is a diagram illustrating an example method of displaying an indicator indicating a blocking area according to various embodiments;

FIG. 16 is a diagram illustrating an example method of at least partially blocking a sound introduced from a direction corresponding to a blocking area using an external sound device according to various embodiments;

FIG. 17 is a diagram illustrating an example method of setting the transparency of an indicator indicating a blocking area, based on a sound level and/or a sound blocking level according to various embodiments;

FIG. 18 is a diagram illustrating an example method of at least partially blocking a sound obtained from a direction corresponding to a blocking area according to various embodiments;

FIG. 19 is a diagram illustrating outputting a spatial sound according to various embodiments; and

FIG. 20 is a diagram illustrating amplifying and outputting a sound obtained from a space designated by a user according to various embodiments.

### DETAILED DESCRIPTION

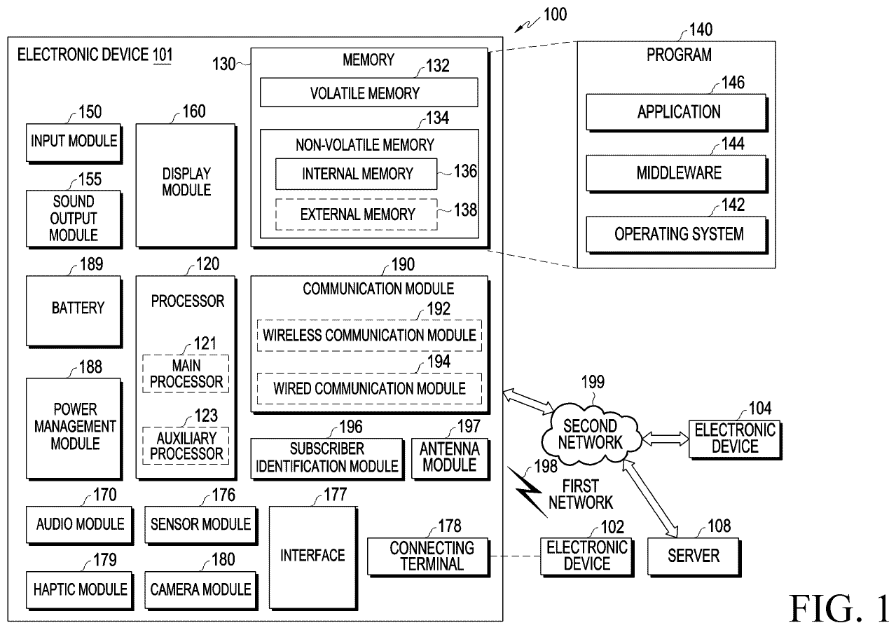

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

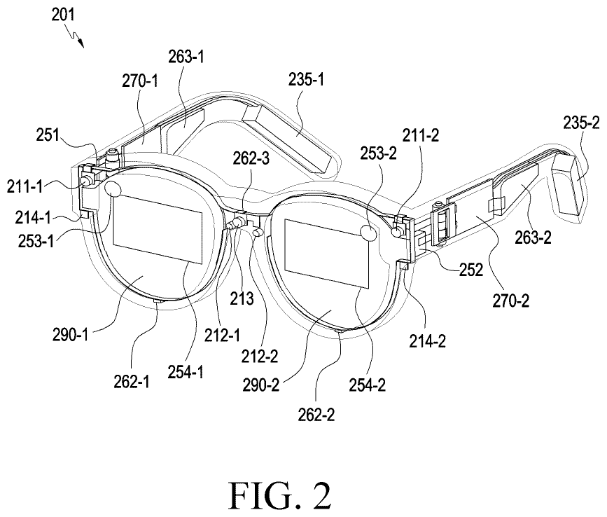

FIG. 2 is a perspective view illustrating an example electronic device 201 according to various embodiments.

Referring to FIG. 2, in an embodiment, the electronic device 201 (e.g., the electronic device 101) may include one or more first cameras 211-1 and 211-2, one or more second cameras 212-1 and 212-2, and one or more third cameras 213. In an embodiment, an image obtained through the one or more first cameras 211-1 and 211-2 may be used for detecting a hand gesture of a user, tracking the user's head, and/or recognizing a space. In an embodiment, the one or more first cameras 211-1 and 211-2 may be global shutter (GS) cameras.

In an embodiment, the one or more first cameras 211-1 and 211-2 may perform a simultaneous localization and mapping (SLAM) operation through depth imaging. In an embodiment, the one or more first cameras 211-1 and 211-2 may perform spatial recognition for six degrees of freedom (6DoF).

In an embodiment, an image obtained through the one or more second cameras 212-1 and 212-2 may be used to detect and track the user's pupils. In an embodiment, the one or more second cameras 212-1 and 212-2 may be GS cameras. In an embodiment, the one or more second cameras 212-1 and 212-2 may correspond to the left eye and the right eye, respectively, and the one or more second cameras 212-1 and 212-2 may have the same performance.

In an embodiment, the one or more third cameras 213 may be high-resolution cameras. In an embodiment, the one or more third cameras 213 may perform an auto-focusing (AF) function and an image stabilization function. In an embodiment, the one or more third cameras 213 may be GS cameras or rolling shutter (RS) cameras.

In an embodiment, the electronic device 201 may include one or more light-emitting elements 214-1 and 214-2. In an embodiment, the light-emitting elements 214-1 and 214-2 may be different from a light source described below that radiates light to a screen display area of a display. In an embodiment, the light-emitting elements 214-1 and 214-2 may radiate light to facilitate pupil detection when detecting and tracking the pupils of the user through the one or more second cameras 212-1 and 212-2.

In an embodiment, each of the light-emitting elements 214-1 and 214-2 may include a light-emitting diode (LED). In an embodiment, the light-emitting elements 214-1 and 214-2 may radiate light in an infrared region. In an embodiment, the light-emitting elements 214-1 and 214-2 may be attached adjacent to a frame of the electronic device 201. In an embodiment, the light-emitting elements 214-1 and 214-2 may be positioned adjacent to the one or more first cameras 211-1 and 211-2, and may assist the one or more first cameras 211-1 and 211-2 in gesture detection, head tracking, and spatial recognition when the electronic device 201 is used in a dark environment. In an embodiment, the light-emitting elements 214-1 and 214-2 may be positioned adjacent to the one or more third cameras 213, and may assist the one or more third cameras 213 in obtaining an image when the electronic device 201 is used in a dark environment.

In an embodiment, the electronic device 201 may include batteries 235-1 and 235-2. The batteries 235-1 and 235-2 may store power to operate the remaining components of the electronic device 201.

In an embodiment, the electronic device 201 may include a first display 251, a second display 252, one or more input optical members 253-1 and 253-2, one or more transparent members 290-1 and 290-2, and one or more screen display portions 254-1 and 254-2.

In an embodiment, the first display 251 and the second display 252 may include, for example, a liquid crystal display (LCD), a digital mirror device (DMD), a liquid crystal on silicon (LCoS), an organic light-emitting diode (OLED), or a micro-light-emitting diode (micro LED).

In an embodiment, when the first display 251 and the second display 252 includes one of the liquid crystal display, the digital mirror display, or the liquid crystal on silicon, the electronic device 201 may include the light source that radiates light to the screen display area of the display. In an embodiment, when the first display 251 and the second display 252 are able to autonomously generate light (e.g., includes one of an organic light-emitting diode or a micro LED), the electronic device 201 may provide a virtual image with a relatively good quality for the user even without including a separate light source.

In an embodiment, the one or more transparent members 290-1 and 290-2 may be positioned to face the eyes of the user when the user wears the electronic device 201. In an embodiment, the one or more transparent members 290-1 and 290-2 may include at least one of a glass plate, a plastic plate, or a polymer. In an embodiment, the user is able to see an outside world through the one or more transparent members 290-1 and 290-2 when wearing the electronic device 201. In an embodiment, the one or more input optical members 253-1 and 253-2 may guide light generated from the first display 251 and the second display 252 to the eyes of the user. In an embodiment, an image based on the light generated from the first display 251 and the second display 252 is formed on the one or more screen display portions 254-1 and 254-2 on the one or more transparent members 290-1 and 290-2, and the user is able to view the image formed on the one or more screen display portions 254-1 and 254-2.

In an embodiment, the electronic device 201 may include one or more optical waveguides (not shown). The optical waveguides may transmit the light generated from the first display 251 and the second display 252 to the eyes of the user. The electronic device 201 may include one optical waveguide corresponding to each of the left eye and the right eye. In an embodiment, the optical waveguides may include at least one of glass, plastic, or a polymer. In an embodiment, the optical waveguides may include a nano-pattern formed, for example, a grating structure having a polygonal or curved shape, on one inner or outer surface. In an embodiment, the optical waveguides may include a free-form prism, in which case the optical waveguides may provide incident light to the user through a reflective mirror. In an embodiment, the optical waveguides may include at least one diffractive element (e.g., a diffractive optical element (DOE) or a holographic optical element (HOE)) or a reflective element (e.g., a reflective mirror), and may guide display light emitted from the light source to the eyes of the user using the at least one diffractive element or the reflective element included in the optical waveguides. In an embodiment, the diffractive element may include an input/output optical member. In an embodiment, the reflective element may include a member causing total reflection.

In an embodiment, the electronic device 201 may include one or more sound input devices 262-1, 262-2, and 262-3 and one or more sound output devices 263-1 and 263-2.

In an embodiment, the electronic device 201 may include a first PCB 270-1 and a second PCB 270-2. The first PCB 270-1 and the second PCB 270-2 may be configured to transmit an electrical signal to a component, such as the one or more first cameras 211-1 and 211-2, the one or more second cameras 212-1 and 212-2, the one or more third cameras 213, the displays, an audio module, and a sensor, included in the electronic device 201. In an embodiment, the first PCB 270-1 and the second PCB 270-2 may include a flexible printed circuit board (FPCB). In an embodiment, the first PCB 270-1 and the second PCB 270-2 may each include a first substrate, a second substrate, and an interposer disposed between the first substrate and the second substrate.

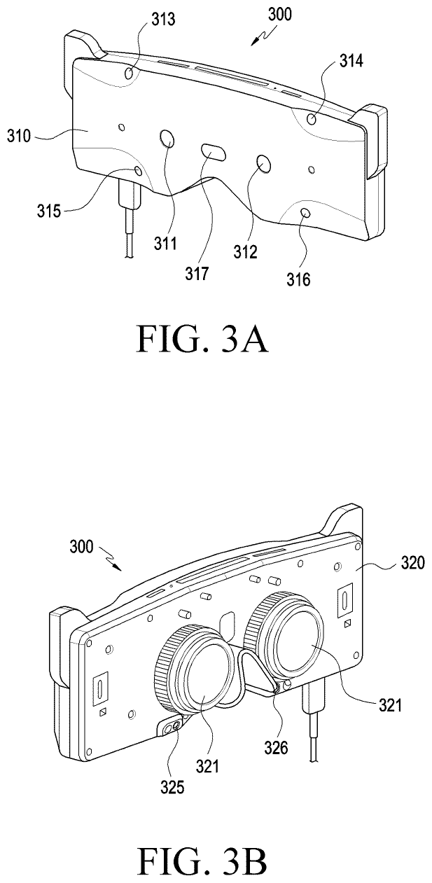

FIG. 3A is a perspective view illustrating the front of an example wearable electronic device 300 according to various embodiments.

FIG. 3B is a perspective view illustrating the back of a wearable electronic device 300 according to various embodiments.

Referring to FIG. 3A and FIG. 3B, in an embodiment, camera modules 311, 312, 313, 314, 315, and 316 and/or a depth sensor 317 for obtaining information related to the surrounding environment of the wearable electronic device 300 may be disposed on a first surface 310 of a housing.

In an embodiment, the camera modules 311 and 312 may obtain an image related to the surrounding environment of the wearable electronic device.

In an embodiment, the camera modules 313, 314, 315, and 316 may obtain an image while the wearable electronic device is worn by a user. The camera modules 313, 314, 315, and 316 may be used for hand detection, tracking, and user gesture (e.g., hand movement) recognition. The camera modules 313, 314, 315, and 316 may be used for 3DoF, 6DoF head tracking, position (space or environment) recognition, and/or movement recognition. In an embodiment, the camera modules 311 and 312 may also be used for hand detection, tracking, and a user gesture.

In an embodiment, the depth sensor 317 may be configured to transmit a signal and receive a signal reflected from a subject, and may be used for identifying the distance to an object as in time of flight (TOF). For example, in replacement of or in addition to the depth sensor 317, the camera modules 313, 314, 315, and 316 may identify the distance to an object.

In an embodiment, a camera module 325 and 326 for face recognition and/or a display 321 (and/or a lens) may be disposed on a second surface 320 of the housing.

In an embodiment, the camera module 325 and 326 for face recognition adjacent to the display may be used for recognizing the face of the user, or may recognize and/or track both eyes of the user.

In an embodiment, the display 321 (and/or the lens) may be disposed on the second surface 320 of the wearable electronic device 300. In an embodiment, the wearable electronic device 300 may not include the camera modules 315 and 316 among the plurality of camera modules 313, 314, 315, and 316. Although not shown in FIG. 3A and FIG. 3B, the wearable electronic device 300 may further include at least one of the components illustrated in FIG. 2.

As described above, the wearable electronic device 300 according to an embodiment may have a form factor for being worn on the head of the user. The wearable electronic device 300 may further include a strap for being secured on a body part of the user and/or a wearing member. The wearable electronic device 300 may provide a user experience based on augmented reality, virtual reality, and/or mixed reality while being worn on the head of the user.

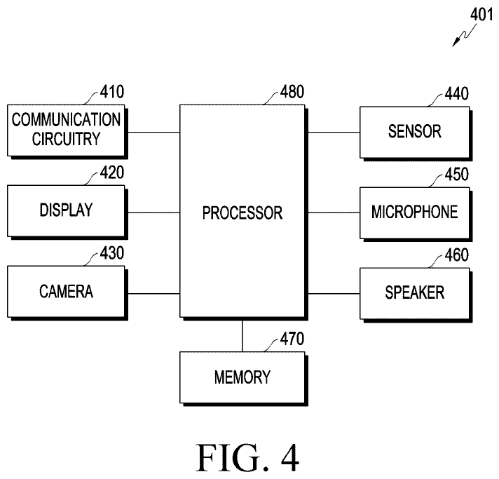

FIG. 4 is a block diagram illustrating an example configuration of a wearable electronic device 401 according to various embodiments.

Referring to FIG. 4, in an embodiment, the wearable electronic device may be the electronic device 201 of FIG. 2 or the wearable electronic device 300 of FIG. 3A and FIG. 3B.

In an embodiment, the wearable electronic device 401 may include communication circuitry 410, a display 420, a camera 430, a sensor 440, a microphone 450, a speaker 460, memory 470, and/or a processor (e.g., including processing circuitry) 480.

In an embodiment, the communication circuitry 410 may be included in the communication module 190 of FIG. 1.

In an embodiment, the communication circuit 410 may connect the wearable electronic device 401 to a sound device wirelessly or via a cable. For example, the communication circuitry 410 may establish a connection with an earphone (also referred to as an “ear bud”) (e.g., an active noise cancellation (ANC) earphone) capable of performing a noise cancelling function using short-range communication (e.g., Bluetooth).

In an embodiment, the display 420 may be included in the display module 160 of FIG. 1.

In an embodiment, the display 420 may include the first display 251 and the second display 252 of FIG. 2, or may include the display 321 (and/or the lens) of FIG. 3A and FIG. 3B.

In an embodiment, the camera 430 may be included in the camera module 180 of FIG. 1.

In an embodiment, the camera 430 may include the one or more first cameras 211-1 and 211-2, the one or more second cameras 212-1 and 212-2, and/or the one or more third cameras 213 of FIG. 2. For example, the camera 430 (e.g., the one or more first cameras 211-1 and 211-2 of FIG. 2) may include an infrared camera capable of detecting a hand gesture of a user, tracking the head of the user, and/or performing spatial recognition.

In an embodiment, the camera 430 may include at least one of the camera modules 313, 314, 315, and 316 of FIG. 3A and FIG. 3B. For example, the camera 430 (e.g., the camera modules 313, 314, 315, and 316) may recognize a gesture (e.g., a hand gesture) of the user. The camera 430 (e.g., the camera modules 313, 314, 315, and 316) may be used for 3DoF or 6DoF head tracking, position (space or environment) recognition, and/or movement recognition.

In an embodiment, the sensor 440 may be included in the sensor module 176 of FIG. 1.

In an embodiment, the sensor 440 may include a depth sensor configured to obtain depth information. For example, the sensor 440 (e.g., the depth sensor) may be configured to transmit a signal and receive a signal reflected from a subject, and may be used for identifying the distance to an object as in time of flight (TOF).

In an embodiment, the sensor 440 may include an inertial sensor (an inertial measurement unit (IMU) sensor). For example, the sensor 440 may include an acceleration sensor, a gyro sensor, and/or a geomagnetic sensor.

In an embodiment, the microphone 450 may be included in the input module 150 of FIG. 1.

In an embodiment, the microphone 450 may include at least one of the sound input devices 262-1, 262-2, and 262-3 of FIG. 2.

In an embodiment, the microphone 450 may obtain a sound introduced from the surroundings of the wearable electronic device 401 (e.g., an ambient sound of the electronic device). In an embodiment, the microphone 450 may include a plurality of microphones.

In an embodiment, when the microphone 450 includes the plurality of microphones, the wearable electronic device 401 may obtain (e.g., calculate) a direction from which a sound comes (hereinafter, also referred to as “direction from which the sound is obtained”), based on the sound introduced through the plurality of microphones.

In an embodiment, when the microphone 450 includes the plurality of microphones, the wearable electronic device 401 may obtain (e.g., calculate) the position of a sound source (hereinafter, an object generating a sound is referred to as “sound source”) that generates a sound, based on the sound introduced through the plurality of microphones.

In an embodiment, the speaker 460 may be included in the sound output module 155 of FIG. 1.

In an embodiment, the speaker 460 may include at least one of the one or more sound output devices 263-1 and 263-2 of FIG. 2.

In an embodiment, the speaker 460 may be a speaker capable of outputting a spatial sound. However, the speaker 460 is not limited thereto, and may be a speaker configured to output a mono sound or a speaker configured to output a stereo sound.

In an embodiment, the memory 470 may be included in the memory 130 of FIG. 1.

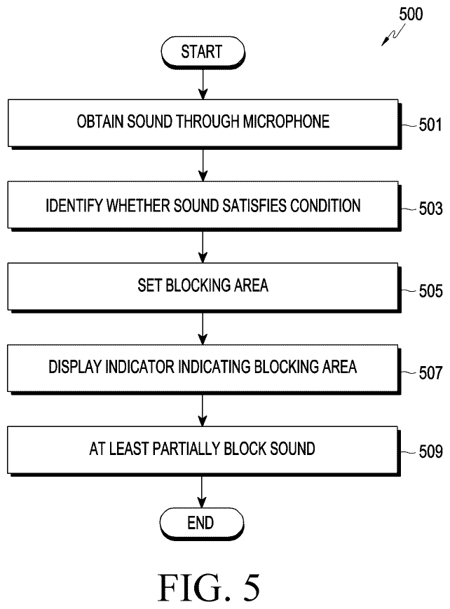

In an embodiment, the memory 470 may include instructions. In an embodiment, the instructions may, cause the wearable electronic device 401 to perform operations described with reference to FIG. 5 to FIG. 20 when individually or collectively executed by one or more processors included in the wearable electronic device 401.

In an embodiment, the processor 480 may be included in the processor 120 of FIG. 1.

In an embodiment, the processor 480 may include various processing circuitry including one or more processors capable of individually or collectively performing the operations described with reference to FIG. 5 to FIG. 20. The processor 480 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the wearable electronic device 401 is illustrated in FIG. 4 as including the communication circuitry 410, the display 420, the camera 430, the sensor 440, the microphone 450, the speaker 460, the memory 470, and the processor 480, but is not limited thereto. For example, the wearable electronic device 401 may further include at least one component included in the electronic device 101 of FIG. 1, the electronic device 201 of FIG. 2, or the wearable electronic device 300 of FIG. 3A and FIG. 3B.

FIG. 5 is a flowchart 500 illustrating an example operation of a wearable electronic device 401 according to various embodiments.

For convenience of explanation, the wearable electronic device 401 is assumed as AR glasses. However, operations to be described below may be applied equally or similarly even when the wearable electronic device 401 is VR glasses (e.g., a VST device).

Referring to FIG. 5, in operation 501, in an embodiment, a processor 480 may obtain a sound through a microphone 450 (e.g., a plurality of microphones) while the wearable electronic device 401 is worn by a user.

In an embodiment, the processor 480 may obtain a sound through the microphone 450, based on execution of an application (hereinafter, referred to as “immersive environment application”) capable of performing the following operations (e.g., operation 501 to operation 509) including setting a blocking area, based on a sound obtained through the microphone 450 and at least partially blocking a sound while the wearable electronic device 401 is worn on the user (e.g., a head of the user).

In an embodiment, the processor 480 may obtain a sound through the microphone 450, based on a designated application being executed in the wearable electronic device 401. For example, the processor 480 may obtain a sound through the microphone 450, based on a document application being executed in the wearable electronic device 401. For example, the processor 480 may execute the immersive environment application, based on the document application being executed in the wearable electronic device 401. The processor 480 may obtain a sound through the microphone 450, based on the immersive environment application being executed.

However, an application designated to obtain a sound through the microphone 450 is not limited to the document application. For example, the processor 480 may set, based on a user input, an application causing to obtain a sound through the microphone 450 when the application is executed.

In an embodiment, the processor 480 may obtain a sound through the microphone 450, based on a user input. However, the disclosure is not limited thereto. For example, the processor 480 may obtain a sound through the microphone 450, based on the wearable electronic device 401 being worn by the user.

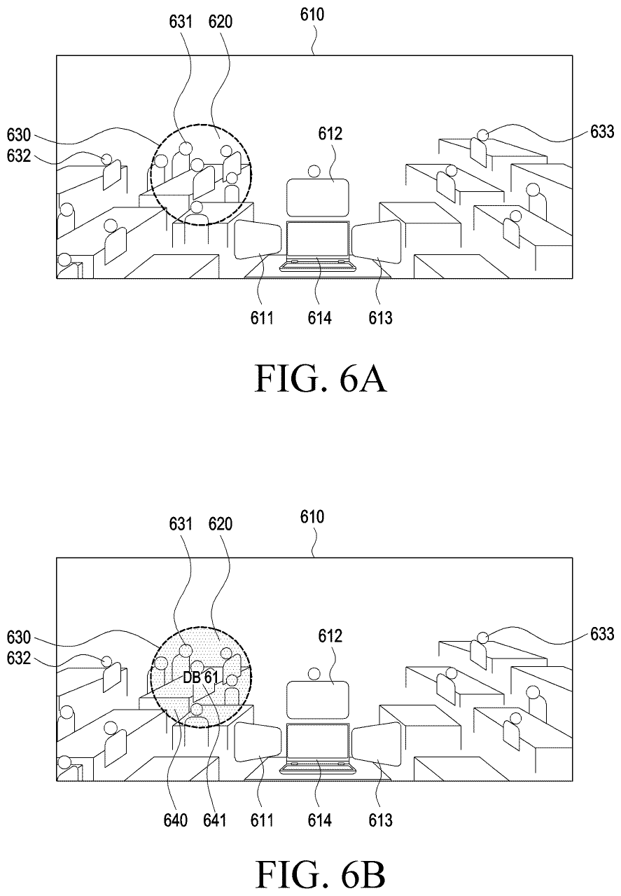

In operation 503, the processor 480 may identify whether the sound obtained through the microphone 450 satisfies a condition (hereinafter, referred to, for example, as a “sound blocking condition”) for at least partially blocking a sound obtained by the wearable electronic device 401 in a real space (also referred to as a “real world space”) around the wearable electronic device 401. The operation 503 will be described in greater detail below with reference to FIG. 6A and FIG. 6B.

FIG. 6A is a diagram illustrating a sound blocking condition according to various embodiments.

FIG. 6B is a diagram illustrating a sound blocking condition according to various embodiments.

Referring to FIG. 6A and FIG. 6B, in an embodiment, FIG. 6A and FIG. 6B may show a real space 610 around the user wearing the wearable electronic device 401. For example, a personal computer (PC) 614 (e.g., a PC in the real world) and people 631, 632, and 633 may be positioned in addition to the user of the wearable electronic device 401 in the real space 610.

In an embodiment, the processor 480 may display one or more virtual panels 611, 612, and 613) in the real space 610 through the display 420. For example, the processor 480 may display, on a transparent member (e.g., the one or more transparent members 290-1 and 290-2), the one or more virtual panels 611, 612, and 613 including execution screens of an application related to a task which the user is performing. In an embodiment, when the wearable electronic device 401 is a VST device, the processor 480 may display the one or more virtual panels in a virtual space instead of the real space 610 on the display 420.

In an embodiment, the processor 480 may obtain a sound through the microphone 450. For example, in FIG. 6A, the processor 480 may obtain a sound introduced through the microphone 450 (hereinafter, also referred to as “sound obtained through the microphone”) from an area 620 indicated by a dotted line 630.

In an embodiment, the processor 480 may identify whether the sound obtained through the microphone 450 satisfies the sound blocking condition for at least partially blocking the sound. For example, the processor 480 may identify whether the sound obtained through the microphone 450 satisfies the sound blocking condition, based on at least one of a size of the sound obtained through the microphone 450, a pattern in which the sound represents, the number of times the sound occurs within a designated time, or a tone of the sound.

In an embodiment, the sound blocking condition may include a noise condition (hereinafter, referred to as a “noise condition”) for identifying whether the sound obtained through the microphone 450 corresponds to noise.

In an embodiment, the noise condition may be stored in memory 470 of the wearable electronic device 401 or in a server that manages the immersive environment application.

In an embodiment, the noise condition may include a noise condition set by default (e.g., a noise condition set by a developer of the immersive environment application) (hereinafter, referred to as “noise condition set as default”) or a noise condition by a user (hereinafter, referred to as “noise condition set by a user”).

In an embodiment, the noise condition set as default may be a condition that is satisfied when a sound having a size greater than or equal to a threshold size (e.g., a sound measured as a decibel greater than or equal to a threshold decibel (dB) or greater), a sound with a uniform pattern (e.g., a pattern of a uniform speed), a sound occurring a designated number of times or greater within a designated time (e.g., about 5 minutes) (e.g., an unspecific collision sound occurring a designated number of times or greater), a sound defined as a local environmental noise, a sound defined as a traffic noise, a sound defined as an aircraft noise, and/or a sound defined as an indoor noise is obtained. For example, the processor 480 may identify that the noise condition set by default is satisfied, based on the volume of the sound obtained through the microphone 450 being the threshold volume or greater.

In an embodiment, the noise condition set as default may be a condition for determining whether to classify a sound as a noise according to a noise evaluation criterion.

In an embodiment, the noise condition set by the user may be a noise condition set based on a user input (e.g., a noise condition according to the individual personality of the user). For example, the noise condition set by the user may be a condition that is satisfied when a sound having a size greater than or equal to a size set by a user input, a sound the same or similar to a sound having a specific pattern (e.g., a regular pattern of a uniform speed of a sound) stored by a user input, and/or a sound the same as or similar to a sound repeated with a specific sound quality (or tone) stored by a user input is obtained.

In an embodiment, the processor 480 may set the noise condition set by the user, based on a user input. For example, the processor 480 may obtain a sound that is introduced into the microphone 450 from an area designated by recognizing a user gesture in the real space while the wearable electronic device 401 is worn on the user or an area pointed by a controller configured to control the wearable electronic device 401 (hereinafter, referred to as a “controller of the wearable electronic device 401”). The processor 480 may store (e.g., record) the sound that is input through the microphone 450 from the designated area or the pointed area, based on the user's voice or an input for an object (e.g., a button) displayed through the display 420. After outputting the stored sound through a speaker 460, the processor 480 may display, through the display 420, information for inquiring the user whether to set the stored sound as a noise satisfying the noise condition set by the user or output the information through the speaker 460. After the information is displayed through the display 420 or output through the speaker 460, the processor 480 may set the stored sound as the noise satisfying the noise condition set by the user, based on a user input. After the noise condition set by the user is set, when a sound the same as or similar to the set noise is obtained through the microphone 450, the processor 480 may identify that the obtained sound satisfies the noise condition set by the user. Although the foregoing examples describe that the noise condition set by the user is set while the wearable electronic device 401 is worn on the user, the disclosure is not limited thereto. For example, an external electronic device (e.g., a smartphone) may store a sound that is introduced to the external electronic device (e.g., a microphone of the external electronic device), based on a user input. The external electronic device may set the stored sound as a noise that satisfies the noise condition set by the user, based on a user input. The external electronic device may transmit the sound set as the noise that satisfies the noise condition set by the user to the wearable electronic device 401 (or a server). The processor 480 may receive the set sound (or the noise condition including the set sound) from the external electronic device (or the server) through communication circuitry 410.

In an embodiment, the processor 480 may display, through the display 420, information indicating an area (hereinafter, also referred to as a “noise detection area”), in a real space, where a sound source that generates the sound satisfying the noise condition is positioned, based on the sound obtained through the microphone 450 satisfying the noise condition. For example, as illustrated in FIG. 6B, the processor 480 may display, through the display 420, an indicator 640 indicating the noise detection area 620 where the sound source (e.g., a person 631) that generates the sound satisfying the noise condition is positioned. In an embodiment, the processor 480 may display, through the display 420, information 641 indicating the size (e.g., 61 decibels) of the sound obtained through the microphone 450 within the noise detection area 620.

In an embodiment, the processor 480 may identify that the sound blocking condition is satisfied, based on the sound obtained through the microphone 450 satisfying the noise condition. However, the disclosure is not limited thereto. In an embodiment, the sound blocking condition for at least partially blocking the sound obtained by the wearable electronic device 401 may be a condition of requiring a level higher than a sound level set in the noise condition. For example, the processor 480 may set the sound level so that the sound level increases as the size of a sound increases. In case that the noise condition is set to be satisfied when a sound having a size of a first threshold size or greater is obtained, if the size of the sound obtained through the microphone 450 is equal to or greater than a second threshold size greater than the first threshold size, the processor 480 may identify that the sound obtained through the microphone 450 satisfies the sound blocking condition. For example, the processor 480 may set the sound level so that the sound level increases as the number of times a sound (e.g., an unspecific collision sound) is repeated within a designated time increases. In case that the noise condition is set to be satisfied when a sound repeated a first number of times or greater within a designated time is obtained, if the sound obtained through the microphone 450 is repeated a second number of times or greater within the designated time, the second number of times being greater than the first number of times, the processor 480 may identify that the sound obtained through the microphone 450 satisfies the sound blocking condition.

In operation 505, in an embodiment, the processor 480 may set, as a blocking area (hereinafter, referred to as “blocking area”), an area in the real space corresponding to the direction in which the sound is obtained, based on the sound obtained through the microphone 450 satisfying the condition (sound blocking condition).

In an embodiment, the blocking area may be an area set to at least partially block a sound obtained in directions from positions within the blocking area to the position of the wearable electronic device 401. For example, the blocking area may be an area set to block a sound which is introduced to the microphone 450 of the wearable electronic device 401 after the sound occurs from the position of a sound source that generates a sound satisfying the sound blocking condition (e.g., the noise detection area that generates a sound satisfying the sound blocking condition) and then passes through the blocking area.

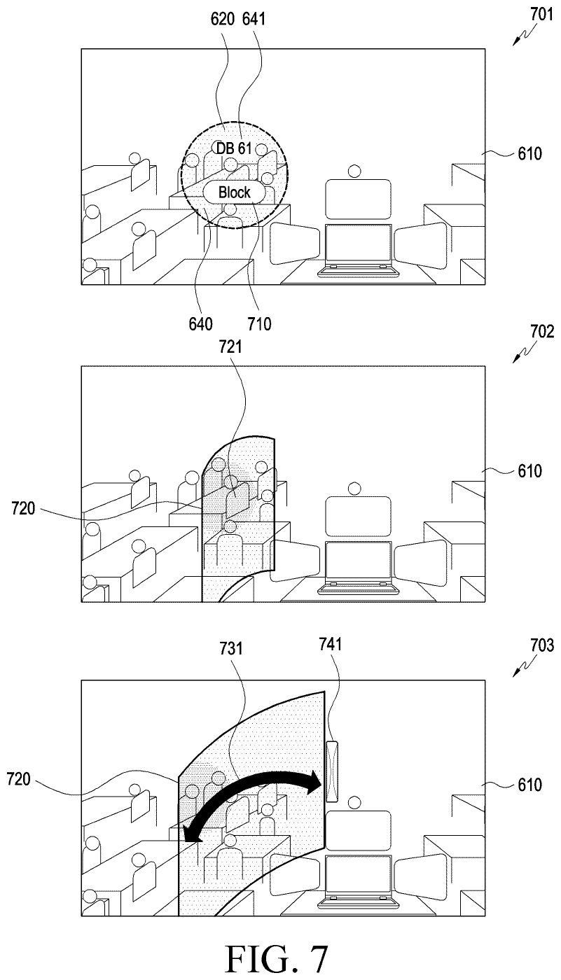

Hereinafter, operation 505 will be described in greater detail with reference to FIGS. 7, 8, 9, 10, 11 and 12 (which may be referred to as FIG. 7 to FIG. 12).

FIG. 7 is a diagram illustrating an example method of setting a blocking area according to various embodiments.

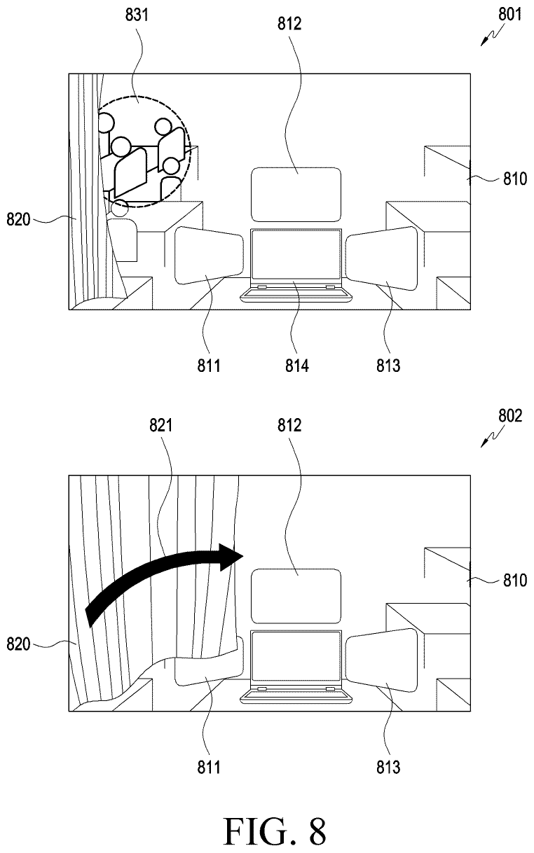

FIG. 8 is a diagram illustrating an example method of setting a blocking area according to various embodiments.

Referring to FIG. 7 and FIG. 8, in an embodiment, the processor 480 may display, through the display 420, an object for selecting whether to set the blocking area, based on the sound obtained through the microphone 450 satisfying the sound blocking condition in operation 503. For example, referring to reference numeral 701 of FIG. 7, as described above, the processor 480 may display, through the display 420, the indicator 640 indicating the noise detection area 620 and information 640 indicating the size of the sound, based on the sound obtained through the microphone 450 satisfying the noise blocking condition. The processor 480 may display, through the display 420, an object 710 for selecting whether to set a blocking area in the noise detection area 620 (e.g., a button for activating a blocking area or a button for activating a virtual blind mode as a mode of performing operations including an operation of displaying an indicator indicating a blocking area and an operation of partially blocking a sound), based on the sound obtained through the microphone 450 satisfying the sound blocking condition. The processor 480 may perform an operation of setting the blocking area, based on a user input to the object 710. However, the operation of setting the blocking area is not limited to the foregoing example. For example, the processor 480 may perform the operation of setting the blocking area, based on a hand gesture in the noise detection area 620 (e.g., a pinch gesture that is input during hovering over the noise detection area 620) without displaying, through the display 420, the object 710.

In an embodiment, referring to reference numeral 702 of FIG. 7, the processor 480 may set a blocking area 720 for at least partially blocking a sound occurred from the noise detection area 620 (e.g., a sound generated from the noise detection area 620 and satisfying the sound blocking condition), based on a user input (e.g., the user input to the object 710 or the hand gesture in the noise detection area 620).

In an embodiment, as illustrated in reference numeral 702 of FIG. 7, the processor 480 may display, through the display 420, an indicator indicating the blocking area 720 so that a portion 721 corresponding to the noise detection area 620 is distinguished from the other portion in the blocking area 720.

In an embodiment, the size (or distribution) of the portion 721 corresponding to the noise detection area 620 in the blocking area 720 may vary depending on the distribution of the sound obtained through the microphone 450 from the noise detection area 620 (e.g., the size of the sound and the area of the noise detection area 620). For example, the size of the portion 721 corresponding to the noise detection area 620 in the blocking area 720 may increase as the size of the sound obtained through the microphone 450 from the noise detection area 620 increases or the area of the noise detection area 620 increases.

In an embodiment, after the blocking area is set, the processor 480 may adjust the position and/or size of the blocking area or rotate the blocking area, based on a user input. For example, referring to reference numeral 702 and reference numeral 703 of FIG. 7, after the blocking area 720 is set, the processor 480 may display, through the display 420, an object (e.g., an object 741) for adjusting the blocking area 720, based on a user input (e.g., an input using a hand gesture or a gaze) to the edge of the blocking area 720. The processor 480 may increase the size of the blocking area 720 in a direction indicated by an arrow 731, based on a user input (e.g., a pinch and drag gesture) to the object.

Referring to FIG. 8, according to an embodiment, the processor 480 may set a blocking area, based on a user gesture, such as an action of drawing a actual curtain. For example, reference numeral 801 and reference numeral 802 of FIG. 8 may represent a real space 810 including a PC 814. The processor 480 may display, through the display 420, virtual panels 811, 812, and 813. Referring to reference numeral 801 of FIG. 8, the processor 480 may display, through the display 420, an object 820 (e.g., a curtain user interface (UI) affordance) having a shape of an actual curtain in a position adjacent to a noise detection area 831 in a position at least partially overlapping the noise detection area 831, based on the sound obtained through the microphone 450 satisfying the sound blocking condition in operation 503. Referring to reference numeral 802 of FIG. 8, the processor 480 may increase the size of the object 820 (or move the position of the object 820), based on a user gesture, such as an action drawing an actual curtain in a direction indicated by an arrow 821 with respect to the object 820. The processor 480 may set an area corresponding to the object 820 the size of which has increased as a blocking area.

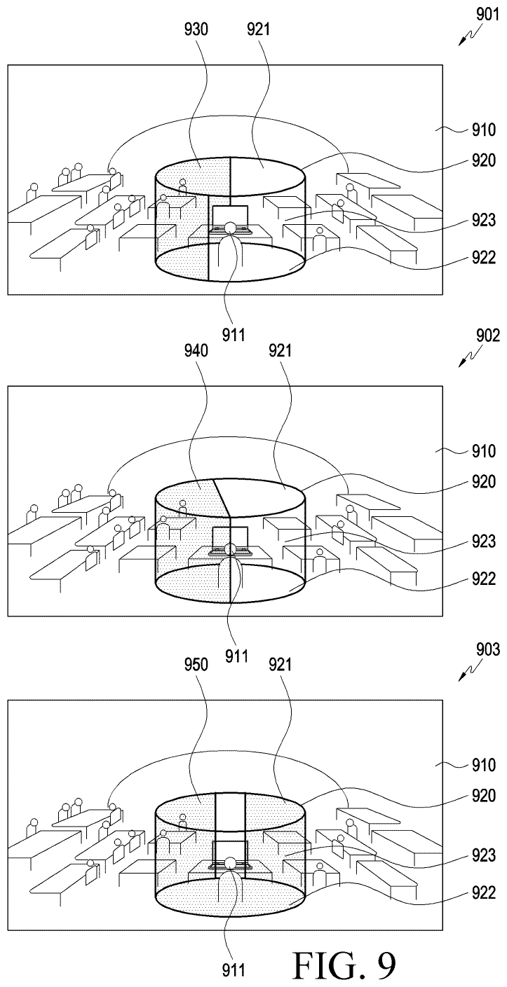

FIG. 9 is a diagram illustrating an example method of setting a blocking area according to various embodiments.

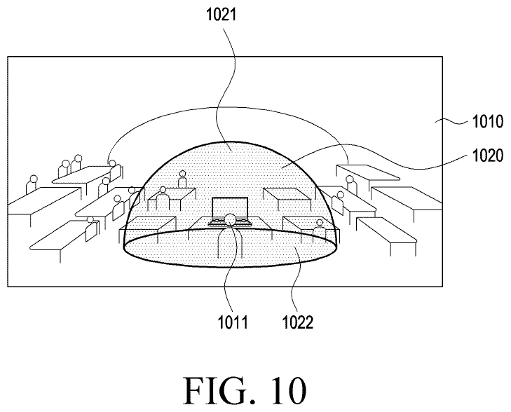

FIG. 10 is a diagram illustrating an example method of setting a blocking area according to various embodiments.

Referring to FIG. 9 and FIG. 10, in an embodiment, the processor 480 may set a space (hereinafter, referred to as “first space”) which is formed by one or more surfaces in a real space based on the position of the wearable electronic device 401. The processor 480 may set, as the blocking area, an area corresponding to a direction in which the sound is obtained on one or more surfaces of the first space, based on the sound obtained through the microphone 450 satisfying the sound blocking condition.

In an embodiment, referring to reference numeral 901 of FIG. 9, a first space 920 (also referred to as “guardian space” or “safety space”) may be set (e.g., formed) by one or more surfaces including a top surface 921, a side surface 923, and a bottom surface 922 in a designated shape, such as a cylinder, based on the position 911 of the wearable electronic device 401 in a real space 910. However, the shape in which the first space is set is not limited to a cylindrical shape. For example, the first space may be set in various shapes.

In an embodiment, the processor 480 may set a blocking area on at least a portion of the one or more surfaces of the first space, based on a user input. For example, referring to reference numeral 901, the processor 480 may set a portion of the side surface 923 of the first space 920 as a blocking area 930, based on a user input. For example, referring to reference numeral 902, the processor 480 may set a portion of the side surface 923 and a portion of the top surface 921 of the first space 920 as a blocking area 940, based on a user input. Referring to reference numeral 903, the processor 480 may set, as a blocking area 950, all the surfaces surrounding the position 911 of the wearable electronic device 401 in the first space 920, based on a user input. In an embodiment, when the blocking area 950 is set to surround the position 911 of the wearable electronic device 401, the user may be more immersed in a task being performed by outputting the spatial sound described below.

In an embodiment, the first space may be set in a shape designated by default or a shape determined based on a user input.

Referring to FIG. 10, according to an embodiment, the processor 480 may set a first space 1020 in a hemispherical shape including a curved surface 1021 and a bottom surface 1022, based on the position 1011 of the wearable electronic device 401 within a real space 1010. For example, the processor 480 may set all the surfaces (e.g., the curved surface 1021 and the bottom surface 1022) surrounding the position 1011 of the wearable electronic device 401 in the first space 1020 as the blocking area.

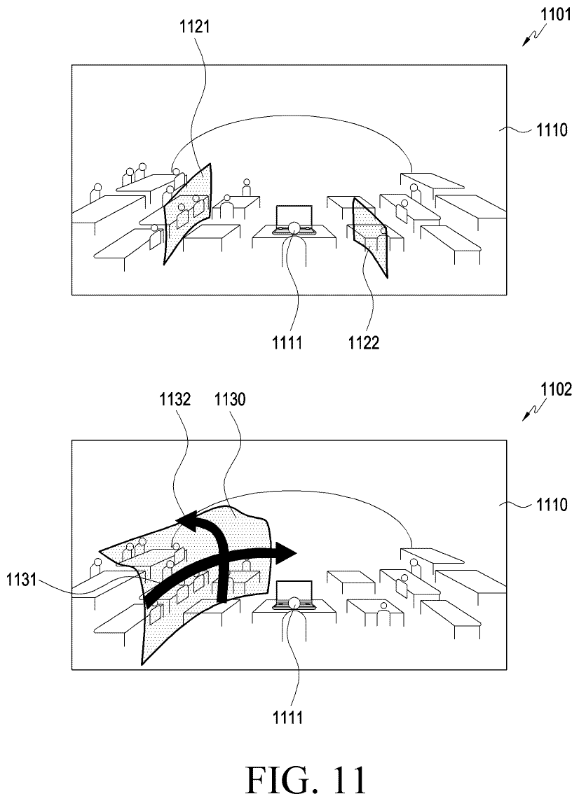

FIG. 11 is a diagram illustrating an example method of setting a blocking area according to various embodiments.

Referring to FIG. 11, in an embodiment, referring to reference numeral 1101 of FIG. 11, the processor 480 may set a plurality of blocking areas. For example, the processor 480 may set a plurality of blocking areas 1121 and 1122 within a real space 1110, based on a plurality of noise detection areas being identified around a position 1111 of the wearable electronic device 401. For example, the processor 480 may set the plurality of blocking areas 1121 and 1122 within the real space 1110, based on a user input.

In an embodiment, after the blocking areas are set or when the blocking areas are set, the processor 480 may adjust the position and/or size of the blocking areas or rotate the blocking areas, based on a user input. For example, referring to reference numeral 1102 of FIG. 11, the processor 480 may expand (or reduce) a blocking area 1130 in a direction indicated by an arrow 1131 or an arrow 1132, based on a user input. However, the disclosure is not limited thereto. For example, the processor 480 may move the position of the blocking area or rotate the blocking area, based on a user input. For example, the processor 480 may transform the blocking area, based on a user input.

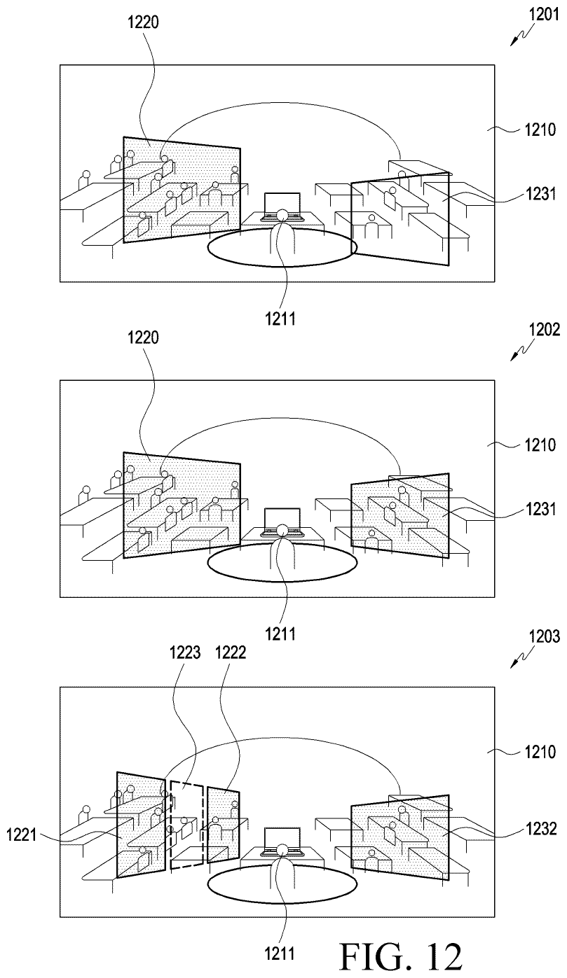

FIG. 12 is a diagram illustrating an example method of setting a blocking area according to various embodiments.

Referring to FIG. 12, in an embodiment, the processor 480 may set, as a blocking area, an area in which a sound is not detected through the microphone 450 or an area which does not satisfy the noise condition in a real space. For example, the user may feel uncomfortable even with a sound that does not satisfy the noise condition. In this case, the processor 480 may set a blocking area, based on a user input (e.g., a hand gesture of the user).

In an embodiment, referring to reference numeral 1201 and reference numeral 1202 of FIG. 12, the processor 480 may set, as a blocking area, a noise detection area 1220 in which a sound satisfying the noise condition occurs, based on the position 1211 of the wearable electronic device 401 in a real space 1210. Referring to reference numerals 1201, the processor 480 may designate an area 1231 that the user wants to set as a blocking area, based on a user input. Referring to reference numeral 1202, the processor 480 may set the designated area 1231 as a blocking area, based on a user input.

In an embodiment, when a plurality of noise detection areas is identified at the same time in a real space, the processor 480 may display at least some of the plurality of noise detection areas differently, based on the priorities of the plurality of noise detection areas.

In an embodiment, in case that the plurality of noise detection areas are identified at the same time in the real space, the processor 480 may prioritize the plurality of noise detection areas.

In an embodiment, the processor 480 may assign a higher priority to a noise detection area that generates a sound satisfying the noise condition set by the user than a noise detection area that generates a sound satisfying the noise condition set by the default between the noise condition set by the user and the noise condition set by the default. However, the disclosure is not limited thereto. For example, the processor 480 may assign a higher priority to the noise detection area that generates the sound satisfying the noise condition set by the user than the noise detection area that generates the sound satisfying the noise condition set by the user between the noise condition set by default and the noise condition set by the user.

In an embodiment, as a sound obtained from a noise detection area corresponds to more items in both items included in the noise condition set by default and items included in the noise condition set by the user, the processor 480 may assign a higher priority to the noise detection area in which the obtained sound is generated. For example, when a sound obtained from a first noise detection area corresponds to a sound having a threshold size or greater and a sound obtained from a second noise detection area corresponds to a sound having a threshold size or greater and is generated a designated number of times within a designated time, the processor 480 may assign a higher priority to the second noise detection area than the first noise detection area.

In an embodiment, the processor 480 may highlight a noise detection area with a high priority among the plurality of noise detection areas and blur a noise detection area with a low priority on the display 420.

In an embodiment, the processor 480 may set, as the blocking area, a noise detection area designated based on a user input among the plurality of noise detection areas. For example, the processor 480 may, based on a user input, set each of the plurality of noise detection areas as a blocking area or set a portion of the plurality of noise detection areas as a blocking area.

In an embodiment, the processor 480 may not set a portion of the plurality of noise detection areas as a blocking area. For example, referring to reference numerals 1202 and 1203 of FIG. 12, the processor 480 may not set a portion 1223 of a noise detection area 1220 among a plurality of noise detection areas 1220 and 1232 as a blocking area and set the other portions 1221 and 1222 of the noise detection area 1220 as blocking areas, based on a user input. For example, the processor 480 may set the noise detection area 1220 as a blocking area, and may then release the portion 1223 of the noise detection area 1220 from the blocking area, based on a user input.

Referring back to FIG. 5, in operation 507, in an embodiment, the processor 480 may display, through the display 420, an indicator indicating the blocking area, based on the position of the wearable electronic device 401.

In an embodiment, the processor 480 may display, through the display 420, the indicator corresponding to the blocking area so that the blocking area is distinguished from the other area in the real space. For example, the processor 480 may display, through the display 420, the indicator corresponding to the blocking area for an area set as the blocking area so that the blocking area is distinguished from other area in the real space. For example, the processor 480 may display, through the display 420, the indicator indicating the blocking area so that the noise detection area is not viewed from the user's field of view by the indicator indicating the blocking area in the real space. Although the foregoing examples are described that the indicator indicating the blocking area is displayed, the disclosure is not limited thereto. For example, the processor 480 may display, through the display 420, an indicator indicating that the blocking area is set instead of the indicator indicating the blocking area.

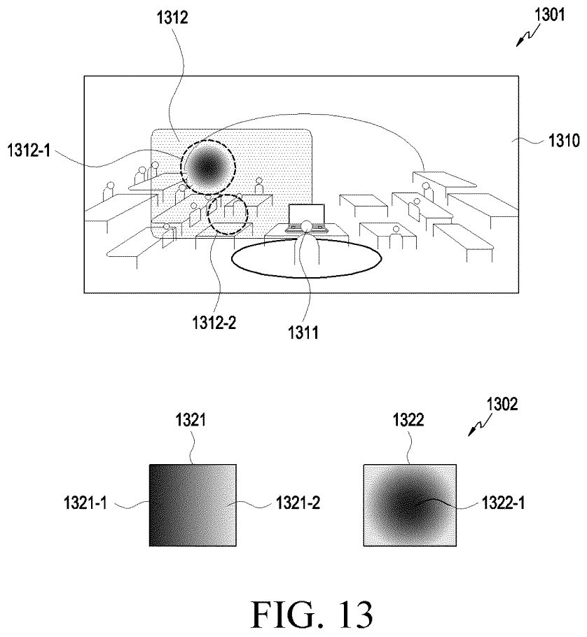

In an embodiment, the processor 480 may display, through the display 420, an indicator which indicates the blocking area and of which the transparency which is adjustable so that the blocking area is distinguished from the other area within the real space. Hereinafter, a method of displaying an indicator indicating a blocking area will be described in greater detail with reference to FIGS. 13, 14 and 15 (which may be referred to as FIG. 13 to FIG. 15).

FIG. 13 is a diagram illustrating an example method of displaying an indicator indicating a blocking area according to various embodiments.

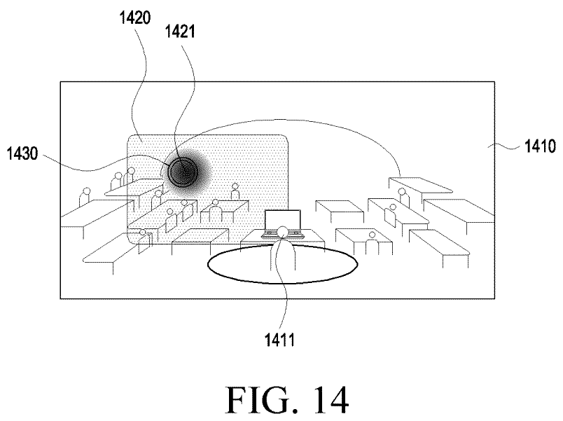

FIG. 14 is a diagram illustrating an example method of displaying an indicator indicating a blocking area according to various embodiments.

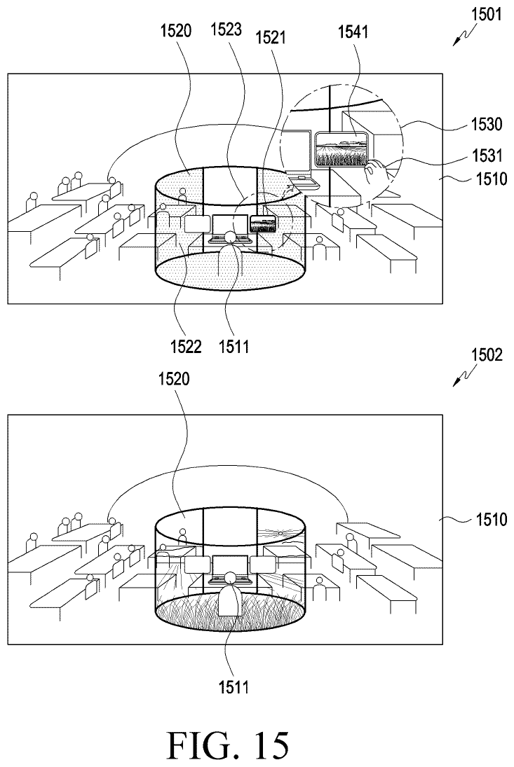

FIG. 15 is a diagram illustrating an example method of displaying an indicator indicating a blocking area according to various embodiments.

Referring to FIG. 13 to FIG. 15, in an embodiment, referring to reference numeral 1301 of FIG. 13, the processor 480 may display, through the display 420, an indicator 1312 corresponding to a blocking area set based on the position 1311 of the wearable electronic device 401 in a real space 1310. The processor 480 may partially set (e.g., adjust) transparency in the indicator 1312, based on the distribution of a sound. For example, referring to reference numeral 1301, the size of a sound obtained through the microphone 450 from a noise detection area corresponding to a first area indicated by an arrow 1312-1 (hereinafter, also referred to as “first area”) within the indicator 1312 may be greater than the volume of a sound obtained through the microphone 450 from a noise detection area corresponding to a second area (hereinafter, also referred to as a “second area”) indicated by an arrow 1312-2 within the indicator 1312. In this case, the processor 480 may display, through the display 420, the indicator 1312 such that the transparency of the first area is lower than the transparency of the second area (e.g., the first area is displayed more opaque than the second area).

In an embodiment, when the size of the sound obtained through the microphone 450 from the noise detection area corresponding to the first area is greater than the size of the sound obtained through the microphone 450 from the noise detection area corresponding to the second area, the processor 480 may display, through the display 420, the indicator 1312 such that the size of the first area is greater than the size of the second area.

In an embodiment, when the area of the noise detection area corresponding to the first area is greater than the area of the noise detection area corresponding to the second area, the processor 480 may display, through the display 420, the indicator 1312 such that the transparency of the first area is lower than the transparency of the second area (e.g., the first area is displayed more opaque than the second area).

In an embodiment, when the area of the noise detection area corresponding to the first area is greater than the area of the noise detection area corresponding to the second area, the processor 480 may display, through the display 420, the indicator 1312 such that the size of the first area is greater than the size of the second area.

In an embodiment, the processor 480 may apply a gradation effect to the first area and/or the second area, based on a point corresponding to the center of the noise detection areas (e.g., a point where the loudest sound is generated in the noise detection areas) within the indicator 1312. For example, referring to reference numeral 1302 of FIG. 13, within an indicator area 1321, a portion 1321-1 may be closer to a point corresponding to the center of a noise detection area than a portion 1321-2. The processor 480 may apply a gradient effect to the area 1321 to become darker from the portion 1321-2 to the portion 1321-1. Referring to reference numeral 1302 of FIG. 13, within an indicator area 1322, a portion 1322-1 may be a portion corresponding to the center of a noise detection area. The processor 480 may apply a gradient effect to the area 1322 to become brighter from the portion 1322-1 to a peripheral portion.

In an embodiment, while displaying, through the display 420, the indicator corresponding to the blocking area, the processor 480 may release sound blocking setting for a portion corresponding to the noise detection area within the blocking area, based on a user input to the portion corresponding to the noise detection area within the indicator. For example, in FIG. 14, the processor 480 may display, through the display 420, an indicator 1420 indicating a blocking area, based on the position 1411 of the wearable electronic device 401 in a real space 1410. A portion 1421 corresponding to a noise detection area in the indicator 1420 may be displayed to be distinguished from the other portion. The processor 480 may release sound blocking setting for an area corresponding to the portion 1421, based on a user input (e.g., a double-tap input or a long-press input indicated by a circle 1430) to the portion 1421 corresponding to the noise detection area. For example, the processor 480 may not perform an operation of blocking at least part of a sound to be input to the microphone 450 after passing through the area corresponding to the portion 1421 corresponding to the noise detection area in the blocking area.

In an embodiment, after releasing the sound blocking setting for the portion corresponding to the noise detection area, when obtaining a user input (e.g., a double-tap input or a long-press input) to the portion 1421, the processor 480 may set the area corresponding to the portion 1421 as a blocking area again.

In an embodiment, the processor 480 may select the indicator indicating the blocking area, based on a user input.

Referring to reference numeral 1501 of FIG. 15, the processor 480 may set a blocking area 1520 within a first space 1522 set based on the position 1511 of the wearable electronic device 401 in a real space 1510. The processor 480 may display, through the display 420, an image 1541 selected from a gallery application (or an image retrieved through an Internet search) on a panel 1521. Referring to reference numeral 1501, a portion 1530 may be an enlargement of a portion 1523. The processor 480 may display, through the display 420, the image 1541 as an indicator in the blocking area 1520, based on a user input (e.g., based on a gesture input 1531 of pinching and then dragging the image 1541 displayed on the panel 1521 to the blocking area 1520). For example, referring to reference numeral 1502 of FIG. 15, the processor 480 may display, through the display 420, the image 1541 as the indicator corresponding to the blocking area 1520.

In an embodiment, the foregoing example describes that the image 1541 selected from the gallery application (or the image retrieved through the Internet search) is displayed as the indicator corresponding to the blocking area 1520, but the disclosure is not limited thereto. For example, the processor 480 may generate an image corresponding to a situation and/or the content of a space indicated by a voice of the user, based on the voice input through the microphone 450, using generative artificial intelligence (AI). The processor 480 may recommend the generated image as the indicator corresponding to the blocking area 1520. The processor 480 may display, through the display 420, the generated image as the indicator corresponding to the blocking area 1520, based on a user input.

Referring back to FIG. 5, in operation 509, in an embodiment, the processor 480 may control the wearable electronic device 401 to at least partially block the sound obtained from the direction corresponding to the blocking area.

In an embodiment, the processor 480 may at least partially block the sound that is introduced to the microphone 450 after the sound passes through the blocking area.

In an embodiment, based on the wearable electronic device 401 is capable of performing noise cancellation, the processor 480 may at least partially block the sound obtained as noise from the direction corresponding to the blocking area through the microphone 450 and the speaker 460. For example, the processor 480 may output, through the speaker 460, a sound having an opposite waveform from that of the sound introduced from the direction corresponding to the blocking area through the microphone 450, thereby at least partially blocking the sound introduced from the direction corresponding to the blocking area.

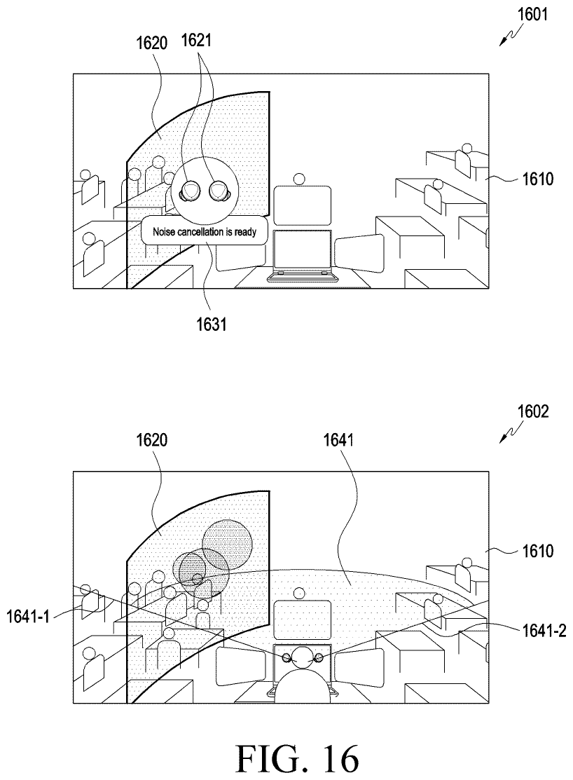

In an embodiment, when the wearable electronic device 401 is not capable of performing noise cancellation, the processor 480 may control an external sound device (e.g., an active noise cancellation (ANC) earphone) (hereinafter, referred to as an “external sound device”), which is connected to the wearable electronic device 401 and capable of performing noise cancellation, to at least partially block the sound introduced from the direction corresponding to the blocking area. Hereinafter, a method of at least partially blocking a sound introduced from a direction corresponding to a blocking area using an external sound device will be described in greater detail with reference to FIG. 16.

FIG. 16 is a diagram illustrating an example method of at least partially blocking a sound introduced from a direction corresponding to a blocking area using an external sound device according to various embodiments.

Referring to FIG. 16, in an embodiment, the processor 480 may identify whether an external sound device (e.g., an ANC earphone) having a history of being connected to the wearable electronic device 401 exists around the wearable electronic device 401. For example, when a history of connecting the wearable electronic device 401 and the external sound device via Bluetooth^{TM} exists, the processor 480 may have the Bluetooth address and identifier (ID) of the external sound device stored in the memory 470. The processor 480 may display, through the display 420, information indicating that it is possible to block noise through the external sound device, based on the external sound device being in a state of being connectable to the wearable electronic device 401. For example, referring to reference numeral 1601 of FIG. 16, a blocking area 1620 may be set within a real space 1610. The processor 480 may display, through the display 420, information 1631 indicating that it is possible to block noise through the external sound device that is connectable to the wearable electronic device 401 (e.g., information indicating that noise blocking is ready) and an image 1621 indicating the external sound device. After displaying, through the display 420, the information 1631 and the image 1621, the processor 480 may connect the wearable electronic device 401 and the external sound device through the communication circuitry 410, based on a user input.

In an embodiment, after connecting the wearable electronic device 401 and the external sound device through the communication circuitry 410, the processor 480 may at least partially block a sound obtained from a direction corresponding to the blocking area.

In an embodiment, after connecting the wearable electronic device 401 and the external sound device through the communication circuitry 410, the processor 480 may perform mapping a reference direction of the wearable electronic device 401 and a reference direction of the external sound device.

In an embodiment, while the wearable electronic device 401 (and the external sound device) is worn on the user, the processor 480 may obtain a sound through the microphone 450 at a first time and then obtain (e.g., calculate) the direction of the obtained sound (hereinafter, referred to as “first direction”). While the external sound device (and the wearable electronic device 401) is worn on the user, the processor 480 may receive information about the direction of a sound (hereinafter, referred to as a “second direction”) obtained by the external sound device through a microphone of the external sound device from the external sound device through the communication circuitry 410 at a time substantially the same as the first time.

In an embodiment, the processor 480 may perform mapping the reference direction of the wearable electronic device 401 and the reference direction of the external sound device, based on the first direction and the second direction. For example, the processor 480 may compare the first direction and the second direction, thereby calculating a correlation between the reference direction of the wearable electronic device 401 and the reference direction of the external sound device (e.g., the difference between a vector representing the reference direction of the wearable electronic device 401 and a vector representing the reference direction of the external sound device).

In an embodiment, after performing the mapping, the processor 480 may calculate the direction of the obtained sound, based on the sound being obtained from the direction corresponding to the blocking area. The processor 480 may calculate a direction in which the external sound device performs noise cancellation, based on the calculated direction of the sound and the calculated correlation (e.g., the correlation between the reference direction of the wearable electronic device 401 and the reference direction of the external sound device). The processor 480 may transmit the calculated direction in which noise cancellation is performed to the external sound device through the communication circuitry 410. The external sound device may perform noise cancellation, based on the direction in which noise cancellation is performed received from the wearable electronic device 401. For example, when a sound is obtained through the microphone of the external sound device in the direction in which noise cancellation is performed received from the wearable electronic device 401, the external sound device may output a sound for offsetting the sound through a speaker of the external sound device.

In an embodiment, the processor 480 may transmit the calculated direction in which noise cancellation is performed and a degree to which the external sound device performs noise cancellation (e.g., a noise blocking degree or a level to which the noise cancellation is performed) to the external sound device through the communication circuitry 410.

In an embodiment, after connecting the wearable electronic device 401 and the external sound device through the communication circuitry 410, the processor 480 may perform mapping the spatial coordinates of the wearable electronic device 401 and the spatial coordinates of the external sound device.

In an embodiment, while the wearable electronic device 401 (and the external sound device) are worn on the user, the processor 480 may obtain depth information (hereinafter, referred to as “first depth information”) about the direction of the sound (e.g., a noise detection area) obtained through the microphone 450 at the first time through a depth sensor (and/or an infrared camera). For example, referring to reference numeral 1602 of FIG. 16, the processor 480 may obtain first depth information about a noise detection area positioned within the view angle range of the depth sensor (e.g., a view angle range 1641 formed by lines 1641-1 and 1641-2) at the first time. While the external sound device (and the wearable electronic device 401) is worn on the user, the external sound device may obtain depth information (hereinafter, referred to as “second depth information”) about the direction of the sound obtained through the microphone of the external sound device through a depth sensor (and/or an infrared camera) of the external sound device at the time substantially the same as the first time. The external sound device may transmit the second depth information to the wearable electronic device 401. The processor 480 may perform mapping the spatial coordinates of the wearable electronic device 401 and the spatial coordinates of the external sound device by comparing the first depth information and the second depth information. For example, the processor 480 may calculate a correlation between the spatial coordinates of the wearable electronic device 401 and the spatial coordinates of the external sound device (e.g., the relative difference between the spatial coordinates of the wearable electronic device 401 and the spatial coordinates of the external sound device) by comparing the first depth information and the second depth information.

In an embodiment, after performing the mapping operation, the processor 480 may calculate the direction of the obtained sound, based on the sound being obtained from the direction corresponding to the blocking area. The processor 480 may calculate a direction in which the external sound device performs noise cancellation, based on the calculated direction of the sound and the calculated correlation (e.g., the correlation between the spatial coordinates of the wearable electronic device 401 and the spatial coordinates of the external sound device). The processor 480 may transmit the calculated direction in which noise cancellation is performed to the external sound device through the communication circuitry 410. The external sound device may perform noise cancellation, based on the direction in which noise cancellation is performed received from the wearable electronic device 401.

In an embodiment, the processor 480 may set (e.g., adjust) the transparency of an indicator indicating the blocking area, based on the size of the sound obtained through the microphone 450 (hereinafter, also referred to as a “sound level”) and/or the degree to which the sound is blocked (hereinafter, also referred to as a “sound blocking level”).

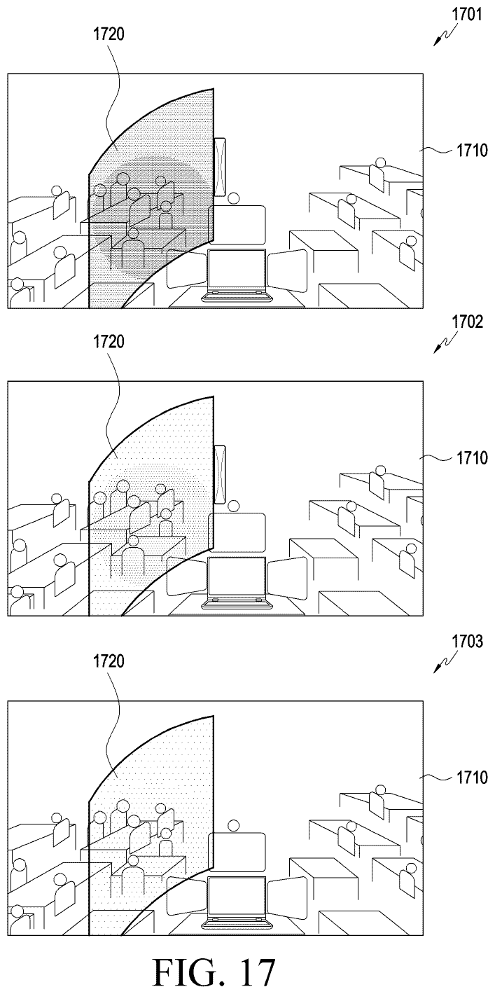

FIG. 17 is a diagram illustrating an example method of setting the transparency of an indicator indicating a blocking area, based on a sound level and/or a sound blocking level according to various embodiments.

Referring to reference numerals 1701, 1702, and 1703 of FIG. 17, reference numeral 1701 may show a case in which a sound obtained from a direction corresponding to a blocking area set in a real space 1710 is not blocked (e.g., a case in which a sound blocking level, which is set to range from 0 to 100, is about 0), reference numeral 1702 may show a case in which the sound obtained from the direction corresponding to the blocking area is partially blocked (e.g., a case in which the sound blocking level, which is set to range from 0 to 100, is about 50), and reference numeral 1703 may show a case in which the sound obtained from the direction corresponding to the blocking area 1720 is substantially completely blocked (e.g., a case in which the sound blocking level, which is set to range from 0 to 100, is about 100).

In an embodiment, as shown in reference numerals 1701, 1702, and 1703, the processor 480 may set the transparency of an indicator indicating the blocking area such that the indicator indicating the blocking area has high transparency in the order of reference numerals 1701, 1702, and 1703 according to the sound blocking level.

In an embodiment, the processor 480 may set the transparency of the indicator such that the transparency of the indicator indicating the blocking area decreases as the level of the sound obtained from the direction corresponding to the blocking area increases.

In an embodiment, the processor 480 may set the transparency of the indicator such that a portion corresponding to a noise detection area within the indicator of the blocking area is displayed transparent, based on a sound generated from a sound source positioned in the noise detection area not being detected as the sound source moves to a different position.

In an embodiment, the processor 480 may output information for causing the user to move to a position distant from the noise detection area. For example, the processor 480 may display, through the display 420, information for guiding the user to a position or direction in which the sound may be obtained with a size lower than the size of a sound satisfying the foregoing sound blocking condition. For example, the processor 480 may display, through the display 420, information for guiding the user to at least one of positions or directions in which a sound satisfying the noise blocking condition may be obtained with a size lower than the current size of the sound when obtaining the sound.

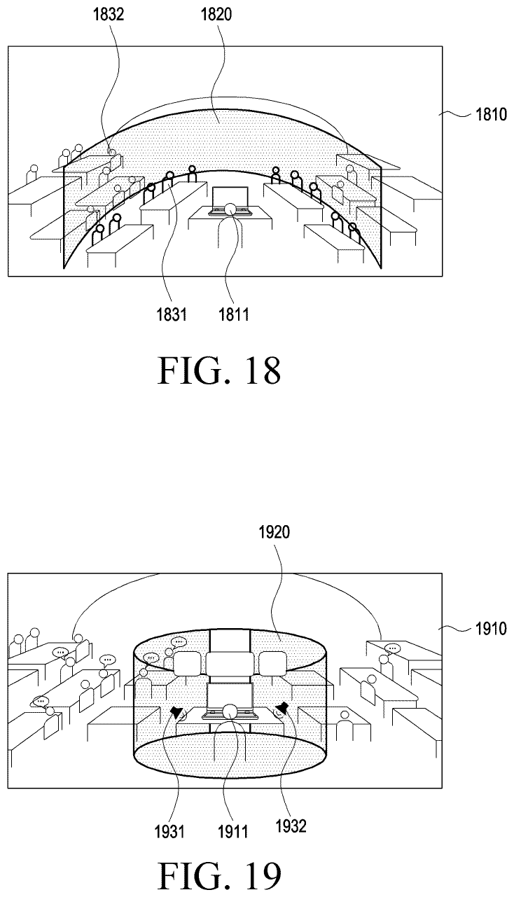

In an embodiment, when the blocking area is set, the processor 480 may not block a sound obtained through the microphone 450 without passing through the blocking area in the direction corresponding to the blocking area, which will be described in greater detail below with reference to FIG. 18.

FIG. 18 is a diagram illustrating an example method of at least partially blocking a sound obtained from a direction corresponding to a blocking area according to various embodiments.

Referring to FIG. 18, in an embodiment, when a blocking area is set, the processor 480 may at least partially block a sound passing through the blocking area and obtained through the microphone 450.

In an embodiment, when a blocking area is set, the processor 480 may not block a sound obtained through the microphone 450 without passing through the blocking area in a direction corresponding to the blocking area. For example, in FIG. 18, after a blocking area 1820 is set in a real space 1810, the processor 480 may at least partially block a sound generated from a sound source 1832 positioned outside the blocking area 1820, based on the position 1811 of the wearable electronic device 401. The processor 480 may not block a sound obtained from a sound source 1831 positioned inside the blocking area 1820, based on the position 1811 of the wearable electronic device 401. The sound generated from the sound source 1831 may be obtained through the microphone 450 without passing through the blocking area 1820. The processor 480 may obtain the direction of the sound generated from the sound source 1831 through the microphone 450 and obtain depth information about the sound source 1831 through a depth sensor (and/or an infrared camera), thereby identifying that the sound source 1831 is positioned within the blocking area 1820.

FIG. 19 is a diagram illustrating an example of outputting a spatial sound according to various embodiments.

Referring to FIG. 19, in an embodiment, the processor 480 may output a spatial sound in addition to or in place of an operation of at least partially blocking a sound obtained from a direction corresponding to a blocking area.

In an embodiment, the processor 480 may set a first space 1920 (e.g., a cylindrical first space) described above, based on the position 1911 of the wearable electronic device 401 in a real space 1910. For example, the processor 480 may set all surfaces surrounding the position 1911 of the wearable electronic device 401 in the first space 1920 as a blocking area.

In an embodiment, the processor 480 may output a spatial sound through the speaker 460 while the blocking area is set.

In an embodiment, in FIG. 19, the processor 480 may output the spatial sound through the speaker 460 so that the user perceives that the sound is output from virtual sound source 1931 and 1932 positioned within the first space while the blocking area is set.

In an embodiment, the processor 480 may output the spatial sound through the speaker 460 so that the user perceives that the sound is output from a virtual sound source positioned in a direction corresponding to the blocking area within the first space while the blocking area is set.

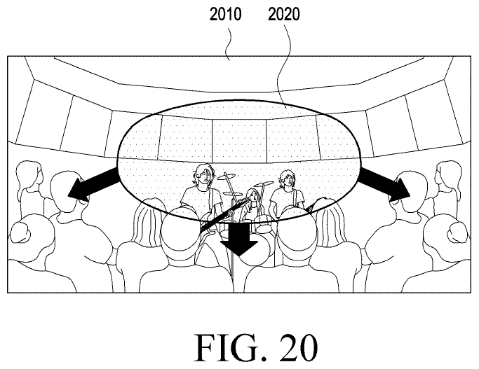

FIG. 20 is a diagram illustrating an example of amplifying and outputting a sound obtained from a space designated by a user according to various embodiments.

Referring to FIG. 20, in an embodiment, the processor 480 may designate a space within a real space by a user input (e.g., a gesture input) while a blocking area is set. For example, in FIG. 20, the processor 480 may designate a space 2020 within a real space 2010, based on a user input. The processor 480 may amplify and output a sound generated in the designated space 2020.

In an embodiment, the real space 2010 may be a space where a concert is held. The user may designate a space 2020 where a sound desired to be amplified and output is generated within the real space 2010 (e.g., a space where a singer is positioned or a space where a speaker is positioned). The wearable electronic device 401 may amplify and output a sound generated from the space 2020 designated by the user through the speaker 460, thereby enabling the user to be immersed in the concert without being disturbed by ambient noise.

In an embodiment, when an image (e.g., the image 1541 of FIG. 15) selected by a user input is displayed as an indicator corresponding to a blocking area, the processor may output the audio of the selected image through the speaker 460 while the blocking area is set.

The wearable electronic device 401 is described as AR glasses through FIG. 5 to FIG. 20, but is not limited thereto. For example, at least some of the foregoing operations may be applied equally or similarly even when the wearable electronic device 401 is VR glasses (e.g., a VST device).

A wearable electronic device according to an embodiment may include a display, a microphone, a speaker, at least one processor including processing circuitry, and memory storing instructions. The instructions may, when individually or collectively executed by the at least one processor, cause the wearable electronic device to obtain a sound through the microphone in a state in which the wearable electronic device is worn on a user. The instructions may, when individually or collectively executed by the at least one processor, cause the wearable electronic device to identify whether the sound obtained through the microphone satisfies a condition for at least partially blocking a sound obtained by the wearable electronic device in a real space around the wearable electronic device. The instructions may, when individually or collectively executed by the at least one processor, cause the wearable electronic device to set an area in the real space corresponding to a direction from which the sound is obtained as a blocking area, based on the obtained sound satisfying the condition. The instructions may, when individually or collectively executed by the at least one processor, cause the wearable electronic device to display, through the display, an indicator representing the blocking area, based on a position of the wearable electronic device. The instructions may, when individually or collectively executed by the at least one processor, cause the wearable electronic device to at least partially block at least a portion of a sound obtained from a direction corresponding to the blocking area.

In an embodiment, the wearable electronic device may further include a communication circuitry. The instructions may, when individually or collectively executed by the at least one processor, cause the wearable electronic device to control an external sound device to perform noise cancellation on at least the portion of the sound obtained from the direction corresponding to the blocking area, based on the wearable electronic device being, through the communication circuitry, connected to the external sound device capable of performing noise cancellation.

In an embodiment, the instructions may, when individually or collectively executed by the at least one processor, cause the wearable electronic device to set a first space formed by one or more surfaces in the real space, based on the position of the wearable electronic device. The instructions may, when individually or collectively executed by the at least one processor, cause the wearable electronic device to set an area corresponding to the direction from which the sound is obtained on the one or more surfaces of the first space as the blocking area, based on the sound obtained through the microphone satisfying the condition.

In an embodiment, the instructions may, when individually or collectively executed by the at least one processor, further cause the wearable electronic device to output a spatial sound through the speaker such that the user perceives that a sound is outputted from a virtual sound source located in the first space. The instructions may, when individually or collectively executed by the at least one processor, further cause the wearable electronic device to amplify a sound obtained through the microphone from a space designated by an input of the user in the real space and output the amplified sound through the speaker.

In an embodiment, the instructions may, when individually or collectively executed by the at least one processor, further cause the wearable electronic device to set a transparency of the indicator, based on a size of the obtained sound. The instructions may, when individually or collectively executed by the at least one processor, further cause the wearable electronic device to adjust the transparency of the indicator, based on a degree to which the sound obtained from the direction corresponding to the blocking area is blocked.

In an embodiment, the instructions may, when individually or collectively executed by the at least one processor, further cause the wearable electronic device to set an area designated based on an input of the user in the real space as the blocking area.

In an embodiment, the instructions may, when individually or collectively executed by the at least one processor, further cause the wearable electronic device to adjust at least one of a size of the blocking area or a position of the blocking area, based on an input of the user.

In an embodiment, the instructions may, when individually or collectively executed by the at least one processor, cause the wearable electronic device to identify whether the sound obtained through the microphone satisfies the condition, based on at least one of a size of the sound obtained through the microphone, a pattern represented by he sound, a number of times the sound occurs within a designated time, or a tone of the sound.

In an embodiment, the instructions may, when individually or collectively executed by the at least one processor, further cause the wearable electronic device to display, through the display, information for guiding at least one of a position or a direction where a sound, when the sound satisfying the condition is obtained, is to be obtained with a size smaller than a current size of the sound.

In an embodiment, the instructions may, when individually or collectively executed by the at least one processor, further cause the wearable electronic device to release at least a portion of the blocking area, based on an input of the user, after the blocking area is set. The instructions may further cause the wearable electronic device to restore at least the released portion of the blocking area, based on an input of the user, after at least the portion of the blocking area is released.

A method according to an embodiment may include obtaining a sound through a microphone of a wearable electronic device in a state in which the wearable electronic device is worn on a user. The method may include identifying whether the sound obtained through the microphone satisfies a condition for at least partially blocking a sound obtained by the wearable electronic device in a real space around the wearable electronic device. The method may include, based on the sound obtained through the microphone satisfying the condition, setting, as a blocking area, an area in the real space, the area corresponding to a direction from which the sound is obtained. The method may include based on a position of the wearable electronic device, displaying, through a display of the wearable electronic device, an indicator representing the blocking area. The method may include at least partially blocking a sound obtained from a direction corresponding to the blocking area.

In an embodiment, at least partially blocking the sound obtained from the direction corresponding to the blocking area comprises may include based on the wearable electronic device being, through communication circuitry of the wearable electronic device, connected to an external sound device capable of performing noise cancelling, controlling the external sound device to perform the noise cancelling on at least a portion of the sound obtained from the direction corresponding to the blocking area.

In an embodiment, setting, as the blocking area, the area in the real space may include based on the position of the wearable electronic device, setting a first space formed by one or more surfaces in the real space. setting, as the blocking area, the area in the real space may include based on the sound obtained through the microphone satisfying the condition, setting, as the blocking area, an area on the one or more surfaces of the first space, the area corresponding to the direction from which the sound is obtained.

In an embodiment, the method may further outputting a spatial sound through a speaker such that the user perceives that a sound is outputted from a virtual sound source located in the first space. The method may further include amplifying a sound obtained from a space in the real space through the microphone, the space being designated by an input of the user, and outputting, through the speaker, the amplified sound.

In an embodiment, the method may further include based on a size of the obtained sound, setting a transparency of the indicator. The method may further include based on a degree by which the sound obtained from the direction corresponding to the blocking area is blocked, adjusting the transparency of the indicator.

In an embodiment, the method may further include setting, as the blocking area, an area designated based on an input of the user in the real space.

In an embodiment, the method may further include based on an input of the user, adjusting at least one of a size of the blocking area or a position of the blocking area.

In an embodiment, identifying whether the obtained sound satisfies the condition may include based on at least one of a size of the sound obtained through the microphone, a pattern represented by the sound, a number of times by which the sound occurs within a designated time, or a tone of the sound, identify whether the sound obtained through the microphone satisfies the condition.

In an embodiment, the method may further include displaying, through the display, information for guiding at least one of a position or a direction where a sound, when the sound satisfying the condition is obtained, is to be obtained with a size smaller than a current size of the sound.

A non-transitory computer-readable storage medium according to an embodiment may record computer-executable instructions, and the computer-executable instructions may, when individually or collectively executed by at least one processor, cause the wearable electronic device to obtain a sound through a microphone of the wearable electronic device in a state in which the wearable electronic device is worn on a user. The computer-executable instructions may, when individually or collectively executed by the at least one processor, cause the wearable electronic device to identify whether the sound obtained through the microphone satisfies a condition for at least partially blocking a sound obtained by the wearable electronic device in a real space around the wearable electronic device. The computer-executable instructions may, when individually or collectively executed by the at least one processor, cause the wearable electronic device to based on the sound obtained through the microphone satisfying the condition, set, as a blocking area, an area in the real space, the area corresponding to a direction from which the sound is obtained. The computer-executable instructions may, when individually or collectively executed by the at least one processor, cause the wearable electronic device to based on a position of the wearable electronic device, display, through a display of the wearable electronic device, an indicator representing the blocking area. The computer-executable instructions may, when individually or collectively executed by the at least one processor, cause the wearable electronic device to at least partially block a sound obtained from a direction corresponding to the blocking area.

The structure of data used in the foregoing embodiments of the disclosure may be recorded in a computer-readable recording medium through various methods. The computer-readable recording medium includes a storage medium, such as a magnetic storage medium (e.g., a ROM, a floppy disk, and a hard disk) and an optical reading medium (e.g., a CD-ROM and a DVD).

What is claimed is:

1. A wearable electronic device comprising:
a display;
a microphone;
a speaker;
at least one processor comprising processing circuitry; and
memory storing instructions that, when executed by the at least one processor individually or collectively, cause the wearable electronic device to:
obtain, through the microphone, a sound in a state where the wearable electronic device is worn on a user,
identify whether the obtained sound satisfies a condition for at least partially blocking a sound obtained by the wearable electronic device in a real space around the wearable electronic device,
based on the sound obtained through the microphone satisfying the condition, set, as a blocking area, an area in the real space, the area corresponding to a direction from which the sound is obtained,
based on a position of the wearable electronic device, display, through the display, an indicator representing the blocking area, and
at least partially block a sound obtained from a direction corresponding to the blocking area.

2. The wearable electronic device of claim 1, further comprising communication circuitry,
wherein the instructions, when executed by the at least one processor individually or collectively, cause the wearable electronic device to:
based on the wearable electronic device being, through the communication circuitry, connected to an external sound device capable of performing noise cancelling, control the external sound device to perform the noise cancelling on at least a portion of the sound obtained from the direction corresponding to the blocking area.

3. The wearable electronic device of claim 1, wherein the instructions, when executed by the at least one processor individually or collectively, cause the wearable electronic device to:
based on the position of the wearable electronic device, set a first space formed by one or more surfaces in the real space, and
based on the sound obtained through the microphone satisfying the condition, set, as the blocking area, an area on the one or more surfaces of the first space, the area corresponding to the direction from which the sound is obtained.

4. The wearable electronic device of claim 3, wherein the instructions, when executed by the at least one processor individually or collectively, further cause the wearable electronic device to:
output a spatial sound through the speaker such that the user perceives that a sound is output from a virtual sound source located in the first space, or
amplify a sound obtained from a space in the real space through the microphone, the space being designated by an input of the user, and output, through the speaker, the amplified sound.

5. The wearable electronic device of claim 1, wherein the instructions, when executed by the at least one processor individually or collectively, cause the wearable electronic device to:
based on a size of the obtained sound, set a transparency of the indicator, and
based on a degree by which the a sound obtained from the direction corresponding to the blocking area is blocked, adjust the transparency of the indicator.

6. The wearable electronic device of claim 1, wherein the instructions, when executed by the at least one processor individually or collectively, further cause the wearable electronic device to:
set, as the blocking area, an area designated based on an input of the user in the real space.

7. The wearable electronic device of claim 1, wherein the instructions, when executed by the at least one processor individually or collectively, further cause the wearable electronic device to:
based on an input of the user, adjust at least one of a size of the blocking area or a position of the blocking area.

8. The wearable electronic device of claim 1, wherein the instructions, when executed by the at least one processor individually or collectively, further cause the wearable electronic device to:
based on at least one of a size of the sound obtained through the microphone, a pattern represented by the sound, a number of times by which the sound occurs within a designated time, or a tone of the sound, identify whether the sound obtained through the microphone satisfies the condition.

9. The wearable electronic device of claim 1, wherein the instructions, when executed by the at least one processor individually or collectively, further cause the wearable electronic device to:
display, through the display, information for guiding at least one of a position or a direction where a sound, when the sound satisfying the condition is obtained, is to be obtained with a size smaller than a current size of the sound.

10. The wearable electronic device of claim 1, wherein the instructions, when executed by the at least one processor individually or collectively, further cause the wearable electronic device to:
after the blocking area is set, based on an input of the user, release at least a portion of the blocking area, and
after at least the portion of the blocking area is released, based on an input of the user, restore at least the released portion of the blocking area.

11. A method comprising:
obtaining, through a microphone of a wearable electronic device, a sound in a state in which the wearable electronic device is worn on a user;
identifying whether the obtained sound satisfies a condition for at least partially blocking a sound obtained by the wearable electronic device in a real space around the wearable electronic device;
based on the sound obtained through the microphone satisfying the condition, setting, as a blocking area, an area in the real space, the area corresponding to a direction from which the sound is obtained;
based on a position of the wearable electronic device, displaying, through a display of the wearable electronic device, an indicator representing the blocking area; and
at least partially blocking a sound obtained from a direction corresponding to the blocking area.

12. The method of claim 11, wherein at least partially blocking the sound obtained from the direction corresponding to the blocking area comprises:
based on the wearable electronic device being, through communication circuitry of the wearable electronic device, connected to an external sound device capable of performing noise cancelling, controlling the external sound device to perform the noise cancelling on at least a portion of the sound obtained from the direction corresponding to the blocking area.

13. The method of claim 11, wherein setting, as the blocking area, the area in the real space comprises:
based on the position of the wearable electronic device, setting a first space formed by one or more surfaces in the real space; and
based on the sound obtained through the microphone satisfying the condition, setting, as the blocking area, an area on the one or more surfaces of the first space, the area corresponding to the direction from which the sound is obtained.

14. The method of claim 13, further comprising:
outputting a spatial sound through a speaker such that the user perceives that a sound is output from a virtual sound source located in the first space; or
amplifying a sound obtained from a space in the real space through the microphone, the space being designated by an input of the user, and outputting, through the speaker, the amplified sound.

15. The method of claim 11, further comprising:
based on a size of the obtained sound, setting a transparency of the indicator; and
based on a degree by which the a sound obtained from the direction corresponding to the blocking area is blocked, adjusting the transparency of the indicator.

16. The method of claim 11, further comprising:
setting, as the blocking area, an area designated based on an input of the user in the real space.

17. The method of claim 11, further comprising:
based on an input of the user, adjusting at least one of a size of the blocking area or a position of the blocking area.

18. The method of claim 11, wherein identifying whether the obtained sound satisfies the condition comprises:
based on at least one of a size of the sound obtained through the microphone, a pattern represented by the sound, a number of times by which the sound occurs within a designated time, or a tone of the sound, identify whether the sound obtained through the microphone satisfies the condition.

19. The method of claim 11, further comprising:
displaying, through the display, information for guiding at least one of a position or a direction where a sound, when the sound satisfying the condition is obtained, is to be obtained with a size smaller than a current size of the sound.

20. A non-transitory computer-readable storage medium having recorded thereon computer-executable instructions, the computer-executable instructions that, when individually or collectively executed by at least one processor of a wearable electronic device, cause a wearable electronic device to:
obtain a sound through a microphone of the wearable electronic device in a state in which the wearable electronic device is worn on a user;
identify whether the obtained sound satisfies a condition for at least partially blocking a sound obtained by the wearable electronic device in a real space around the wearable electronic device;
based on the sound obtained through the microphone satisfying the condition, set, as a blocking area, an area in the real space, the area corresponding to a direction from which the sound is obtained;
based on a position of the wearable electronic device, display, through a display of the wearable electronic device, an indicator representing the blocking area; and
at least partially block a sound obtained from a direction corresponding to the blocking area.
